(19) United States
(12) Patent Application Publication
(10) Pub. No.: US 2009/0008888 A1
(43) Pub. Date: Jan. 8, 2009

(54) Garbage transport device

(76) Inventor: John Paul Boulden, Beaufort, SC (US)

Correspondence Address: JOHN PAUL C. BOULDEN, 302 Meadowbrook St., Hot Springs, AR, 71913, US

(21) Appl. No.: 12/214,274

(22) Filed: Jun. 17, 2008

Related U.S. Application Data
(63) Continuation of application No. 11/639,946, filed on Dec. 15, 2006.

(51) Int. Cl. B62D 63/02; B62D 55/00

(52) U.S. Cl. 280/29; 180/313

(57) ABSTRACT

The embodiment of the garbage transport device encompasses a motor (6) operated platform (7) equipped with removable sides (4) that with the press of a remote control button device (1) transports its contents to the trash pick-up site (13). The platform is affixed to flexible leveling device (3) that molds to the terrain to ensure a level surface. The device is transported on wheels (2) and tracks (9) similar to the device used by a trolley system. The motor contains a sensor (5) for remote control and a timing device (14) that can be programmed to retract the platform at a time set by the user. An optional housing device (8) protects the platform and is a convenient storage area for the exterior garbage cans.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to the delivery of garbage from one location to another.

2. Prior Art

Almost no one likes to perform everyday household tasks such as cleaning the kitchen, the bathrooms and mopping the floor. These chores demand cherished energy to perform and take away from the everyday routine of work, school and needed social/leisure time. Because of the nature of today's fast-paced society, many products have been developed that reduce the amount of time these chores monopolize. For example, the dishwasher has reduced the amount of labor required to wash dishes in half thus leaving the user with precious leisure time.

It can be argued that the most disliked household task is the emptying of the garbage can. This can be an unpleasant chore. Trash many times spills onto the floor leaving a nasty mess to pick up. After the trash is in the can, preparing for the Sanitation Department for pick up once or twice a week is another daunting task: the individual must drag heavy and awkward (for many individuals state issued) cans to the curb (many elderly and handicapped persons may possess additional challenges to this task and it may be dangerous for others to perform).

And the chore is not yet over. After the end of a long day, the cans must be collected and drug back to a sometimes unkempt garage or equivalent space. Additionally, some subdivisions are monitored by homeowner associations and the local state police and fines are issued to residents for leaving their can(s) on the curb over a 23-hour period. Aside from the inconvenience and potential fine, bacteria and disease can be spread by the manual collection of the garbage cans and lids. Safety is also an issue: during the day the empty can(s) advertise to potential burglars that no one is in the house.

The garbage transport device was developed to addresses these dilemmas. This embodiment greatly reduces the time needed to perform the task of bringing trash to and from the curb once or twice a week. It greatly reduces the risk of injury and disease by minimizing the act of handling filthy, heavy and awkward cans. It offers individual freedom to those that are unable to maneuver the cans back and forth to and from the pick-up site. It deters theft and beautifies the neighborhood by cleaning the curb at a set time during each day. It also prevents costly fines caused by forgetting to clear the curb and leaving empty garbage cans on the street overnight.

The garbage transport device is easy to operate and relatively inexpensive to reproduce and can be marketed to any household or business worldwide subscribing to Sanitation Services.

### SUMMARY

This embodiment not only provides a major convenience to the user but also helps to prevent the spread of germs, promotes safety (especially for physically challenged persons), beautifies the neighborhood, and deters theft.

### DRAWINGS—FIGURES

In the drawings, closely related figures have the same number but different alphabetic suffixes.

FIG. 1A shows the remote operating device

FIG. 1B is a rough sketch of one shape of the embodiment's platform, removable sides, flexible leveler system, wheels and tracks (single or double).

FIG. 1C shows a rough sketch of the motor and sensory device.

FIG. 2 shows a rough sketch of the optional housing unit in a rectangular form.

### DRAWINGS—REFERENCE NUMERALS

| | |
|---|---|
| 1 remote control device | 14 timing device/timer |
| 15 housing button | 8 housing |
| 4 removable sides | 10 manual platform button |
| 7 platform | 11 residence |
| 3 flexible leveling devices | 12 public street |
| 2 wheels | 13 public curb |
| 16 handle for housing | 17 metal track device |
| 5 remote control sensor | 18 moving metal device |
| 6 motor | 19 stationary beam-like structure |
| 9 tracks | 20 garbage transport device main unit |

### DETAILED DESCRIPTION—FIGS. 1A, 1B, AND 1C PREFERRED EMBODIMENT

This embodiment would be constructed with commonly know and accepted quality materials to include metal, plastics, and electronic components. The materials used would be durable, non-corrosive, and able to retain coloring for a long period of time.

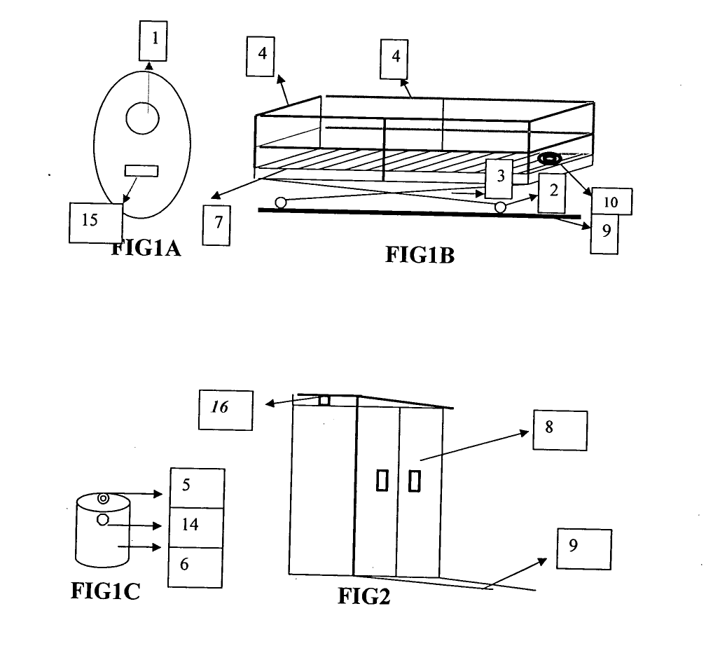

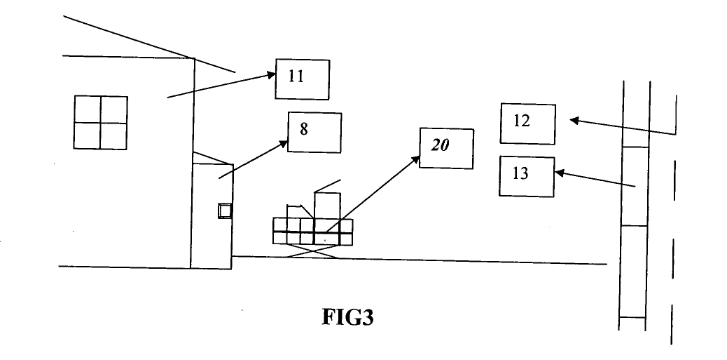

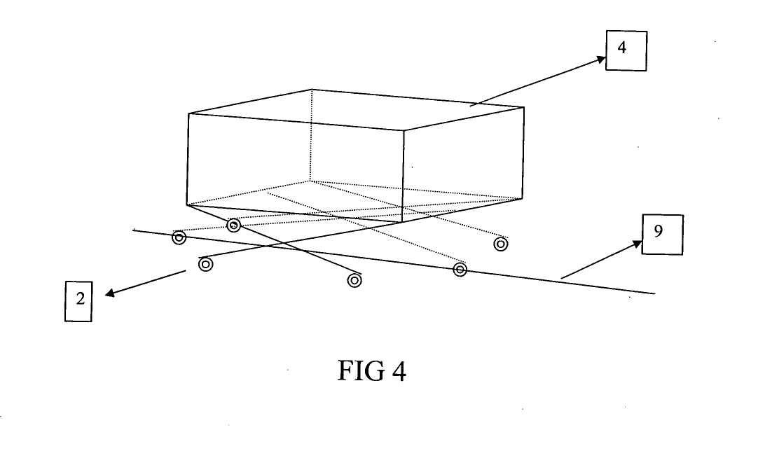

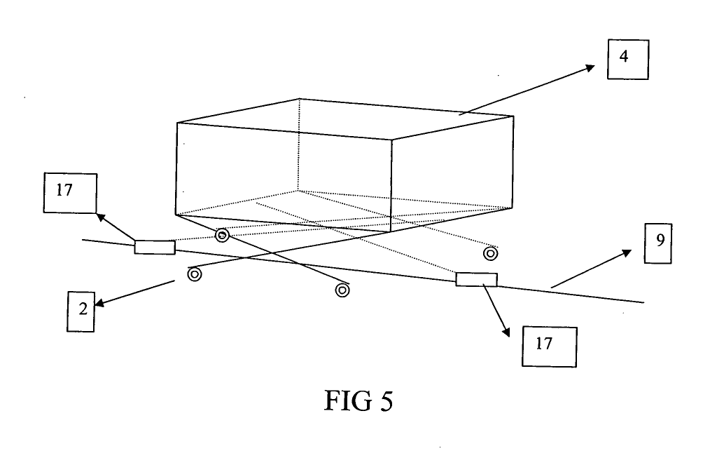

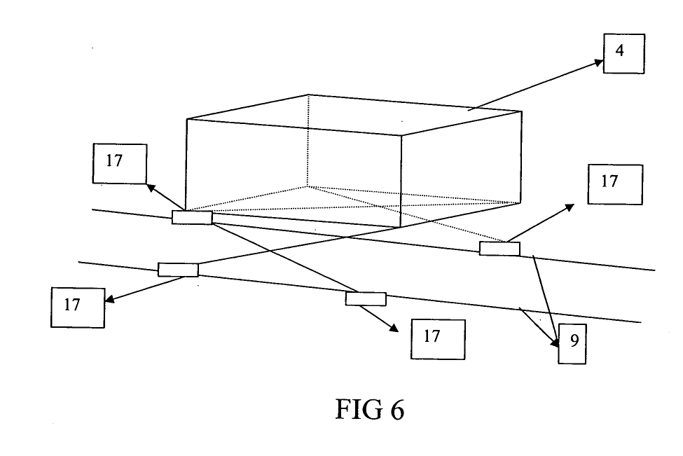

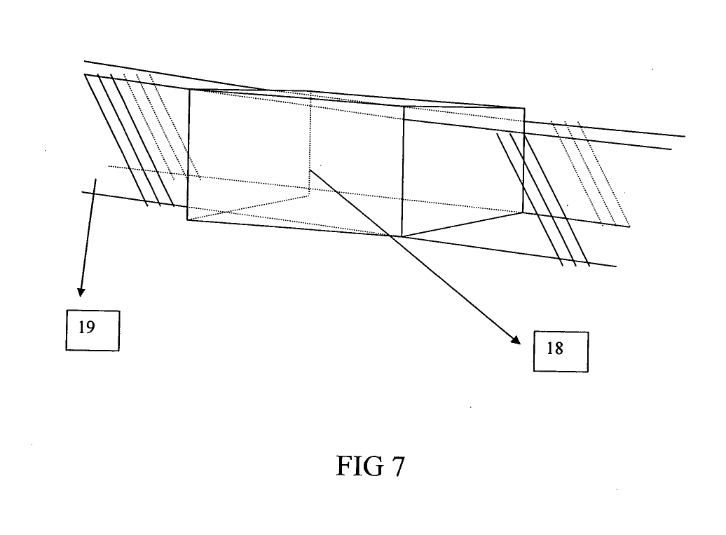

This embodiment of the closure is illustrated in FIG. 1A, FIG. 1B, FIG. 1C, and FIG. 2 and FIG. 3. It consists of a remote control device 1 similar to that used by a garage door opener. The signal 5 is installed on a small motor 6 designed to be attached to an included platform 7 of varying sizes and shapes to hold state issue as well as store bought trash containers, including removable sides 4 that vary in height for stability and about 200-pounds. Flexible levelers 3 are attached to the underside of the platform guiding it to allot for uneven terrain. The platform is attached to wheels 2 and tracks 9 like that of a trolley system that allow for smooth motion to and from the pick-up site.

Optional storage housing 8 is also included with this embodiment. This rectangular housing is large enough to accommodate the platform and the garbage can(s). The housing protects the platform and cans until it is sent to the curb. It opens manually 16 as well as by pressing the housing button 15 located on the remote control device 1. The housing could be most likely stored near the home or business to make it easily accessible. The option not including the hosing device could be designed to store the platform in a convenient place like the inside of a garage.

This embodiment is easy to operate. After the system is installed, the exterior garbage can is placed on the platform. Trash is placed in the can as needed. On collection days, the user presses a button on the remote control sending a signal to the motor on the platform. The platform is then motorized down the tracks to the collection site or curb. A timing device 14 is set on the motor to ensure that the garbage cans retract back to the residence at a certain time after the Sanitation Service pick-up. A button on the remote control and the platform itself 10 may be used to perform this task as well.

### Operation—FIGS. 1,2,3.

The manner of using the garbage transport device is similar to the use of a garage door opener. Namely, the user places the garbage can on the platform 7 (with the removable side for stability 4), presses the remote control devise button 1 or the manual button 10 located on the platform, and the garbage transport device is motorized to the trash pick-up site.

Prior to operation, the user sets the timer 14 on the garbage transport device and programs it to retract back to the launching position 8 at a set time after trash has been collected.

### FIGS. 3-7—Additional Embodiments

Additional embodiments are shown in FIGS. 3, 4, 5, 6, and 7; in each case the garbage transport device 20 is shown from a side view. FIG. 3 shows the garbage transport device 20 with the housing option. In FIG. 4 the garbage transport device is shown with a single track system consisting of wheels 2 and a trolley type track 9. The platform 7 is attached to flexible leveler devices 3 that enable the platform to fluctuate up and down to ensure the platform 7 is kept level. The wheels are affixed to the end of the flexible leveler devise. FIG. 5 shows a track device that does not consist of wheels but of a metal-type delivery system 17 supported by a moving metal part (moving metal devise) 18 wrapped around a stationary beam-like structure 19 that reaches from the drop off to the pick-up site. Joining the moving metal part 18 to the platform 7 is the flexible leveling device 3. Additionally, the platform in FIG. 5 also has wheels attached to flexible leveling devices on the corners to allow for a level steady delivery. FIG. 6 shows the same metal track device with two tracks reaching from the drop off site tot the pick-up site. In FIG. 6 the same metal track device with two tracks reaching from the drop-off site to the pick-up site (no wheels are utilized). In FIG. 6 the flexible leveler devises are attached to directly from the platform to the moving metal part. FIG. 7 shows the metal-type delivery system.

### Advantages

From the description above a number of embodiments of my garbage transport device becomes evident:
(a) The embodiment promotes safety by transporting heavy and awkward size trash containers.
(b) This embodiment provides independence for individuals that are unable to drag their trash cans to the trash pick-up site due to handicap, old age or other physical disabilities.
(c) The embodiment helps to prevent the spread of various kinds of germs and bacteria by reducing individual contact with the trash cans.
(d) This embodiment beautifies the environment by automatically clearing the curb after sanitation pick-up.
(e) It saves the user money by clearing the curb preventing hefty fines imposed by the state government and local neighborhood housing authority.
(f) This embodiment deters theft by removing empty trash cans from the street making it less obvious that the residence or business is empty.
(g) It is a pleasant convince to any user, reducing the time and energy usually needed to perform the essential task and chore of handling the garbage for garbage day.

### CONCLUSIONS, RAMIFICATIONS AND SCOPE

Accordingly, the reader will see that the garbage transport device can be used by anyone able to press a simple button. This device opens the door of independence for those that are unable to perform the task of dragging a heavy trash can to the pick-up site. It improves the environment and deters theft by clearing the curb, beautifying the area and reducing the spread of germs and bacteria associated with garbage handling. It saves the user money by preventing fines caused by trash cans left on the street. It is a convenience that reduces the time and effort traditionally needed on trash day to get the garbage containers to and from the pick-up site for the Sanitation Department.

I claim: A garbage transport device, comprising;

1. a platform;

2. The platform of claim 1 wherein the said platform has removable sides;

3. The platform of claim 1 wherein the said platform can hold about 200 pounds;

4. The platform of claim 1 wherein the said platform has a manual platform button that operates the said device without the use of a remote control device or a timing device;

5. The device of claim 1 wherein the said transport device has optional housing device for protection, user convenience and storage for the said transport device;

6. a flexible lever system that keeps the platform level on uneven terrain;

7. a system that supports the platform for transport;

8. The device of claim 7 wherein the device is transported by a wheel or track system affixed to the said flexible lever system;

9. a motor to produce rotational energy for operation;

10. The system of claim 9 wherein the said system contains a remote control sensor with means for a motor to produce rotational energy;

11. The system of claim 9 wherein the said system contains a timing device with means for a motor to produce rotational energy; whereby the user directs the platform to deliver its contents to a desired location.
